(19) United States
(12) Patent Application Publication
(10) Pub. No.: US 2002/0065772 A1
(43) Pub. Date: May 30, 2002

(54) System, method and program for network user access

(76) Inventors: Bassam A. Saliba, Kirkland, WA (US); Howard Campbell, Bellevue, WA (US); George Webb, Seattle, WA (US); Kyle S. Young, Redmond, WA (US); Bert Speelpenning, Kirkland, WA (US); Michael L. Waterston, Seattle, WA (US)

Correspondence Address: LEE & HAYES PLLC, 421 W RIVERSIDE AVENUE SUITE 500, SPOKANE, WA, 99201

(21) Appl. No.: 09/995,278

(22) Filed: Nov. 26, 2001

Related U.S. Application Data
(63) Continuation of application No. 09/093,953, filed on Jun. 8, 1998.

(51) Int. Cl. G06F 17/60

(52) U.S. Cl. 705/40

(57) ABSTRACT

An electronic financial system for providing financial services over the Internet has multiple billers, a service center, multiple financial institutions. The service center is responsible for distributing electronic bills on behalf of billers. The service center has a Web site that customers can directly access to examine their bills. The financial institutions also offer their own Web sites for their customers. Each financial institution's Web site presents a home page that allows its customers to select different services, such as examining a checking or savings account balance, or conducting a funds transfer. These services are supported locally at the financial institution's Web site. The home page also offers an option to view personal billing statements from the billers, which are stored at the service center. When the customer activates the option to view billing statements, the financial institution's Web server links to the third party's server to access the billing statements without exposing this link to the customer. The customer may actually be handed off to the third party's Web site, or the financial institution's Web server might connect to the service center's server and use an OFX (Open Financial Exchange) protocol, and extensions to this protocol, to retrieve information from the third party's server. The billing statements are branded with the financial institution's name and logo to lead the customer to believe that the financial institution is providing the billing statements rather than the service center.

### RELATED APPLICATIONS

This is a continuation application of U.S. patent application Ser. No. 09/093,953, filed on Jun. 8, 1998, titled System and Method for Presenting Financial Information Using Branded Web Pages, which is incorporated herein by reference.

### TECHNICAL FIELD

This invention relates to electronic financial systems for the Internet. More particularly, this invention relates to systems and methods for presenting electronic bills to customers of a financial institution, such as a bank. The bills, however, reside at an independent third party's location and not at the financial institution. The systems and methods enable integration of the financial institution and the third party to effectively brand the bills with insignia of the financial institution to lead the customers to believe that the financial institution is responsible for the bill presentment, while veiling the third party's participation.

### BACKGROUND

Essentially everyone is familiar with receiving bills. Every month, like clockwork, millions of consumers and businesses receive bills for goods and services. At the end of each billing cycle, a biller generates a bill or statement for each consumer account having a positive or negative account balance, or having transactions that yielded a zero balance. With the growing popularity and use of personal finance computer software, it would be beneficial for billers to distribute their billing statements electronically and to receive payments electronically. Unfortunately, most of the finance computer software focuses primarily on bill payment, with some emphasis on electronic bill management, but with little innovation in bill distribution and presentment. Many of these systems still rely on delivery of paper bills through the U.S. mail.

One problem confronting electronic distribution of bills is a way to coordinate and present all of a consumer's electronic bills in a manner that permits the consumer to conveniently access the bills and pay them as desired. The bills originate from many different billers, who are independent of one another and have different billing cycles.

One approach might be to send the bills via email. An electronic bill payment system described in U.S. Pat. No. 5,465,206, entitled “Electronic Bill Pay System,” which issued Nov. 7, 1995 and is assigned to Visa International, mentions the possibility of distributing bills using either U.S. mail or email. While this tactic is convenient to the biller, the consumer might still experience some problems coordinating the bills that need to be paid. Additionally, the email message may not integrate well with the consumer's personal finance software, making it difficult to receive the bill message and then subsequently launch the finance program to pay the bill.

Apart from bill delivery and presentment, consumers typically pay their bills by drawing on their checking accounts. After the checks are written, consumers reconcile their checking accounts and if needed, transfer funds to cover the payments. Under present bill payment schemes, bill payment and bank account reconciliation are separate and distinct processes. It would be beneficial for the consumer if these processes were more closely integrated.

Accordingly, there is a need to devise an electronic bill presentment system that organizes and conveniently presents electronic bills to the consumer, while additionally integrating more fully the services provided by a bank.

### SUMMARY

This invention concerns a system and method for enabling a financial institution, such as a bank, to present a group of financial services to its customers via a Web site, even though the financial institution may not in fact host some of the financial data that it represents on its Web site to its customers. In providing the services, including those supported by a third party provider, the financial institution would like to offer the data as if it alone were serving the data to the customer. Accordingly, the financial institution contracts with the third party to integrate its resources with the financial institution's Web site offerings.

According to one aspect of this invention, the financial institution has a Web server to support its Web site. The server presents a home page that allows its customers to select different services, such as examining a checking or savings account balance, or conducting a funds transfer. These services are supported locally at the financial institution's Web site. The home page also offers, however, an option to view customer-specific data, such as the customer's personal billing statements that are collected from a variety of different billers (e.g., phone bill, gas bill, cable TV bill, etc.). The customer-specific data is located at the third party provider, which is independent from the financial institution.

The third party also has a server that supports its own Web site. The server stores the customer-specific data offered by the financial institution and can provide that data to a customer of the financial institution any time the customer accesses the third party's Web site. The same data is also made available to the customer through the financial institution's Web site. When the customer is logged onto the financial institution's Web site, the financial institution would like to offer this same data without having the customer feel like he/she has left the financial institution's Web site to access the third party's Web site. Accordingly, when the customer activates the option on the financial institution's home page for viewing the customer-specific data, the financial institution's Web server links to the third party's server to access the customer-specific data without exposing this transfer to the customer.

There are many different degrees of integration between the financial institution's server and the third party's server. According to one implementation for a low level of integration, the financial institution's server hands off the customer to the third party's server by addressing the third party's site URL (universal resource locator). The financial institution's server sends along its own identity, some branding indicia (e.g., logo, background, color), and a customer ID. The third party's server uses the customer ID to retrieve the data belonging to the customer. The third party's server then employs the bank's ID and branding indicia to present the data in a Web page that is formatted, branded, and styled to resemble the financial institution's own Web pages. In this manner, the data is presented in such a way that the customer is led to believe that the financial institution is still sponsoring the customer-specific data rather than the third party.

According to another implementation that involves a higher level of integration, the financial institution's server establishes a secure connection with the third party's server and employs the OFX (Open Financial Exchange) protocol, and extensions to this protocol, to retrieve information from the third party's server. The OFX extensions enable the financial institution's server to request such information as billing summaries, status and type of bills, customer enrollment and logon information, and payment information. The information retrieved from the third party's server can then be presented in new Web page at the financial institution's Web site that contains the financial institution's name and branding indicia. Through integration, the third party provides extended services for the financial institution that are branded as belonging to the financial institution. From the customer's perspective, he/she only visits one location—the financial institution's Web site—to examine his/her financial records.

### BRIEF DESCRIPTION OF THE DRAWINGS

Generally, the same numbers are used throughout the drawings to reference like elements and features.

FIG. 1 shows a block diagram of an electronic billing system for use over the Internet, or other data network.

FIG. 2 shows a home Web page rendered on a computer monitor to present a list of financial services available from a financial institution, such as a bank.

FIG. 3 shows a second Web page rendered on a computer monitor to present a list of bills, wherein the billing data presented in the Web page is located at a third party that is independent from the financial institution.

FIG. 4 shows a billing statement implemented as an HTML document that is rendered on a computer monitor. The billing statement is provided by the third party, but presented within a branding frame that represents the financial institution.

FIG. 5 shows a functional block diagram of the hardware/software components, which form computer servers at the financial institution and the third party.

FIG. 6 shows a flow diagram showing steps for integrating the resources of the financial institution and third party according to a low level of integration.

FIG. 7 shows a flow diagram showing steps for integrating the resources of the financial institution and third party according to a high level of integration.

### DETAILED DESCRIPTION

This invention is directed to a system and method for enabling a financial institution, such as a bank, to present a variety of financial services to its customers, even though the financial institution may not in fact host some of the financial data that it represents to its customers. As an example, the financial institution may sponsor for its customers a Web site that offers a broad selection of financial services and data. As part of this offering, the Web site might reference certain customer-specific data that is actually located at a third party independent from the financial institution. Yet, in providing the services, the financial institution would like to offer the data as if it alone were the full service provider of the customer. Accordingly, the financial institution contracts with the third party to integrate the resources of the third party with those offered by the financial institution.

When a customer of the financial institution wishes to access the customer-specific data supplied by the third party, the financial institution links to the third party without exposing this transfer to the customer. At this point, the third party might actually host the customer and present the customer-specific data. However, the third party presents the data in such a way that the customer is led to believe that the financial institution provides the customer-specific data rather than the third party. Thus, the third party provides an extended service to the financial institution and brands that service as belonging to the financial institution. From the customer's perspective, he/she only visits the financial institution's Web site for all of his/her financial tasks.

For purposes of describing aspects of the invention in an exemplary context, the following implementation is described in the context of an electronic billing system. More particularly, the implementation is directed to a system that facilitates distribution and presentment of electronic bills. Accordingly, within this described implementation, the customer-specific data is the electronic bills and the third party is a bill payment service provider. It is noted, however, that in other contexts the third party provider might be configured to support other types of financial resources besides electronic billing statements.

### Exemplary Billing Context

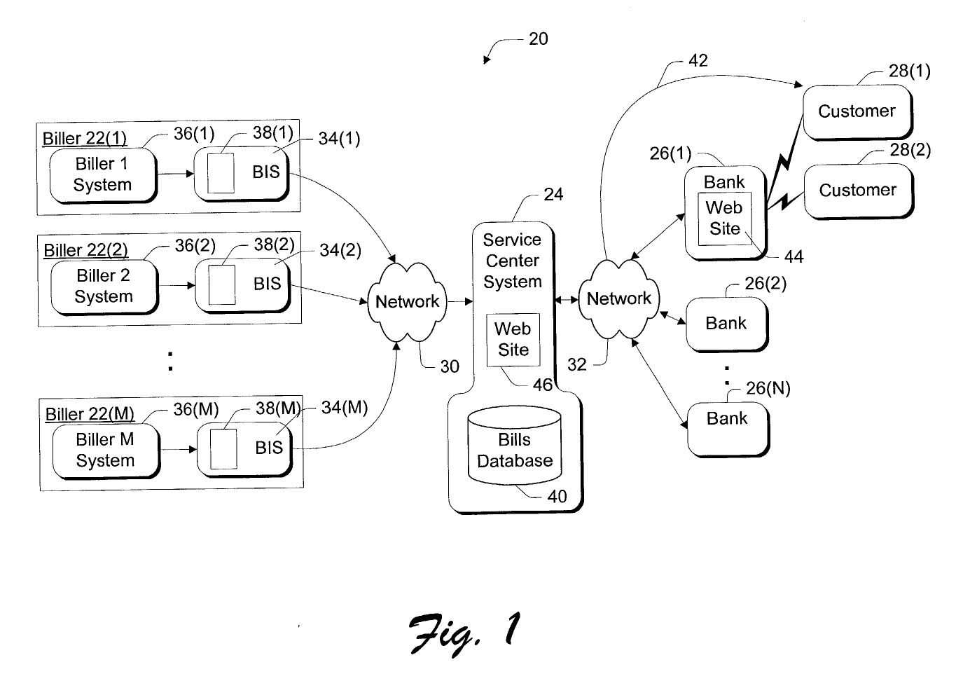

FIG. 1 shows an electronic billing system 20 that enables multiple billers to electronically distribute their billing statements to consumers over a network, such as the Internet. The electronic billing system 20 has multiple participating billers 22(1), 22(2), . . . , 22(M), a service center system 24 resident at a third party billing service, multiple participating banks 26(1), 26(2), . . . , 22(N), and multiple bank customers as represented by customers 28(1) and 28(2).

The electronic billing system 20 facilitates distribution of bills over a data network, such as the Internet. In FIG. 1, a first data network 30 interconnects the billers 22(1)-22(M) with the service center system 24 and a second data network 32 interconnects the service center system 24 with the banks 26(1)-26(N). One or both of the networks 30 and 32 may be embodied as the Internet. Alternatively, one or both of the networks 30 and 32 may be implemented as other types of data networks, such as a proprietary WAN (wide area network).

The billers 22(1)-22(M) are equipped with biller integration systems (BIS) 34(1), 34(2), . . . , 34(M) that facilitate the design of templates for electronically renderable billing statements. The template and billing information are sent to the service center system 24 for electronic distribution of the billing statements. Each biller integration system 34(1)-34(M) integrates with the billers' existing billing system 36(1), 36(2), . . . , 36(M). These billing systems are assumed to be computerized accounting systems that track consumer accounts and generate periodic billing statements.

Each biller integration system 34(1)-34(M) is implemented with a translator 38(1), 38(2), . . . , 38(M), respectively, to integrate with the legacy billing systems 36(1)-36(M). Each translator 38(1)-38(M) is preferably a software component that is uniquely configured to translate billing data from a format used by the existing billing systems 36(1)-36(M) to a format compatible with the biller integration systems 34(1)-34(M). Since the billing systems 36(1)-36(M) are specialized to each particular biller, the translators 38(1)-38(M) are uniquely written for the corresponding legacy billing system of the biller.

The biller integration systems 34 enable the associated billers 22 to create a statement template for an electronically renderable customized billing statement. In a preferred implementation, the BIS 34 is a set of software tools that assists the biller in designing the template. The statement template specifies how the statement will present billing information to a consumer. For instance, the statement template includes various fields in which information will be inserted when the electronic billing statement is generated. As an example, one type of field in the template is a data field that holds billing data, such as the account number, the consumer's name and address, transaction items, amount due, interest amount, minimum payments, due date, and so forth.

Each biller integration system 34(1)-34(M) packages the statement template together with other billing information in a standardized file. More particularly, the file contains the statement template, the account data for the consumers whom the biller wants to receive statements, a set of rules defining the conditions for the conditional fields, and non-billing resources, such as phone numbers for service information, advertisements, biller logos, regulatory messages, give-aways, and so forth. The file format is standardized in the sense that the service center system 24 expects to receive the same formats from each biller.

The biller integration system 34 is described in more detail in co-pending U.S. patent application Ser. No. 880,125, entitled “System and Method for Designing and Distributing Customized Electronic Billing Statements”. This application was filed Jun. 19, 1997 in the names of Howard Campbell, Warren T. Dent, Eric Jakstadt, Darren B. Remington, Bassam Saliba, Bert Speelpenning, George Webb, and is assigned to Microsoft Corporation. This application is incorporated by reference.

The service center system 24 has an electronic bill distribution system that electronically distributes the billing statements on behalf of the billers 22. The service center 24 receives the standardized files from the billers 22 and unpackages the statement template, rules, and resources. The service center 24 then generates the customized billing statements for each biller 22 from the statement template and the billing information received from that biller. The billing statements are stored in a bills database 40 and electronically distributed to the customers over the Internet 32 (or other data network).

The service center delivers the billing statements in one of two ways. One way is to directly distribute the billing statements to the customers over the network 32 (i.e., Internet). This direct distribution is illustrated by communication path 42. The billing statements can be embedded in an email message or notice. A direct distribution system is described in U.S. patent application Ser. No. 08/734,518, entitled “Electronic Bill Presentment and Payment System”, which was filed Oct. 18, 1996 in the names of Darren Remington and Warren Dent, and is assigned to Microsoft Corporation. This application is incorporated by reference.

A second way is to indirectly make the billing statements available through the customer's bank. This invention is primarily directed to this second approach for distributing and presenting electronic billing statements to the customer. The banks 26 support their own Web sites on the Internet, as represented by Web site 44 at bank 26(1). The bank 26(1) has at least one server computer to support the Web site 44. The bank's customer's 28(1) and 28(2) access the bank's Web server via a universal resource locator (URL) for the bank's Web site 44. Additionally, the service center system 24 at the third party provider has at least one server to supports its own Web site 46.

The server computers implemented at the banks 26 and server center system 24 are preferably standalone or clustered personal computers configured to run server operating systems, such as Windows NT from Microsoft Corporation. Alternatively, the server computers might be implemented as UNIX-based computers or as mainframe computers.

### Branding Process

According to an aspect of this invention, the banks 26 and the third party service center 24 cooperate to allow the bank's customers to view, on demand, their personal bills which are stored in the database 40 at the service center 24. The joint cooperation is masked to lead the customers to believe that they are accessing all of their financial information, including billing data, on the bank's Web site. When the service center serves billing data to the customers on behalf of the banks, the service center cloaks the billing data in the bank's branding indicia while veiling its own identity. This process is referred to in this disclosure as the “branding process”.

Customers of the bank access the bank's Web site 44 by establishing a connection to the Internet (e.g., a dialup modem connection) and addressing the bank's URL. The bank's Web site 44 has a home Web page that offers a menu of various services offered by the bank. The home page identifies the bank as the sponsor of the site, presenting such branding indicia as the bank's name, logo, address, telephone number, and so forth.

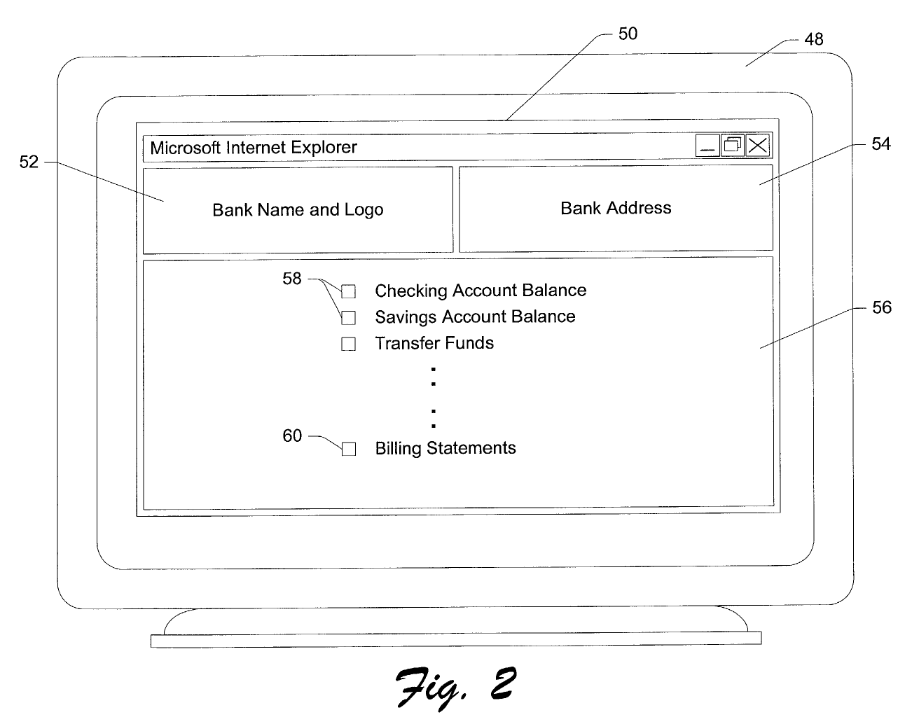

FIG. 2 shows an exemplary home page 50 of a bank as it is rendered on a customer's home computer monitor 48. In this example, the home page is written in a “markup language,” such as HTML (Hypertext Markup Language). HTML is a subset of SGML (Standard Generalized Markup Language). HTML documents are compatible with the World Wide Web. The customer's home computer runs a Web browser application, such as the Internet Explorer browser from Microsoft Corporation, to render the HTML Web page 50.

The home page 50 includes various branding indicia, such as the bank's name and logo 52 and the bank's address 54. In addition, the branding indicia might comprise a particular format or stylistic schema, background color or texture, slogans, and so forth.

The home page 50 provides a menu 56 listing options 58 for various services provided by the bank, such as checking account balance, savings account balance, funds transfer, and so forth. The home page menu 56 also offers an option 60 to view the customer's bills. However, as noted above, the billing statements are physically located on the bills database 40 at the remote service center 24.

Upon activating the “Billing Statements” option 60, the bank's Web server links to the service center's server without exposing this transfer to the customer. The customer still believes that he/she is connected to and communicating with the bank's Web site 44. A new Web page that incorporates the customer's bills is then presented to the customer.

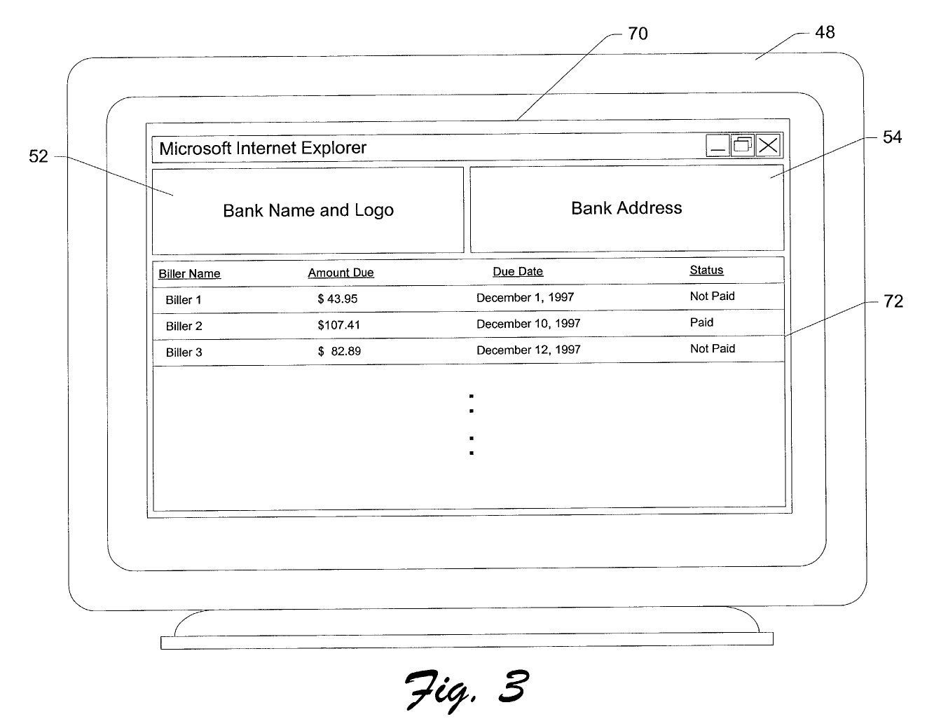

FIG. 3 shows an exemplary new Web page 70, which displays the billing data as it is rendered on a customer's home computer monitor 48. The Web page 70 presents a list 72 of the customer's bills. The page 70 also includes the bank's branding indicia, such as the bank's name and logo 52, bank's address 54, format or stylistic schema, background color or texture, slogans, and so forth. In this manner, the new Web page 70 appears to have been provided by the bank's Web site 44, while the identity of the service center 24 is veiled, to lead the customer to believe that the billing data is provided by the financial institution rather than the service center. At this point, the customer may open any particular bill, review the itemized purchases, the amount due, and due date.

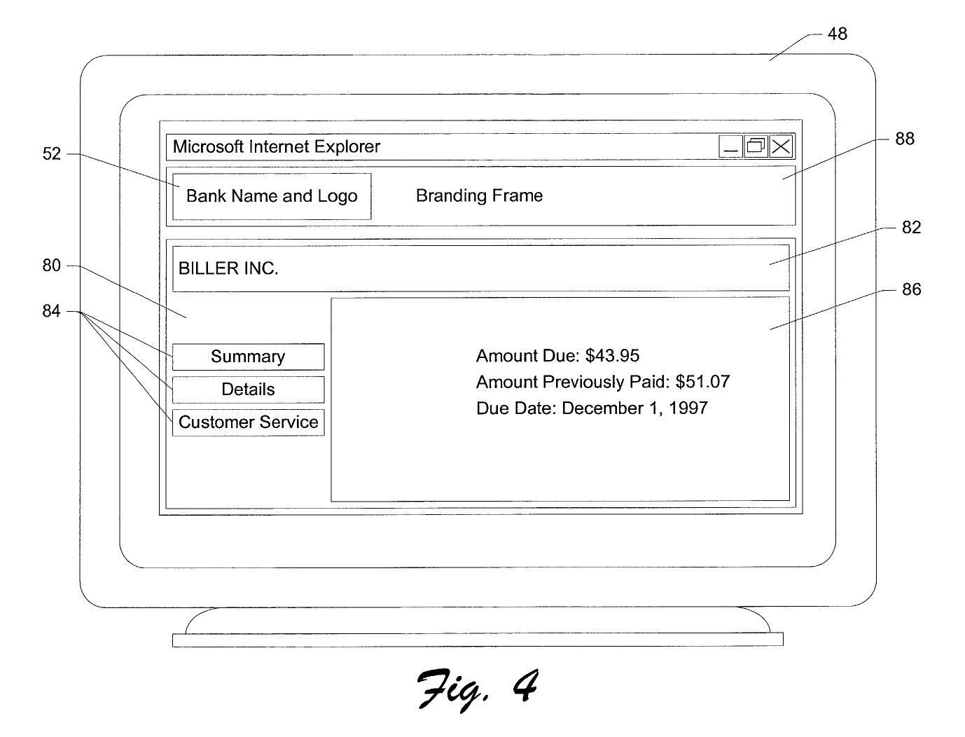

FIG. 4 shows an exemplary billing statement 80 for a company named “Biller Inc.” as it is rendered on the customer's monitor 48. In this example, the billing statement 80 is written in HTML and rendered on the customer's computer using the Web browser application. The billing statement 80 has a banner stripe 82 across the top of the screen to show biller and customer information. The banner strip may also contain advertisements, announcements, or other types of resources.

The billing statement 80 has multiple softkeys or buttons 84 that form tabbed navigation points to facilitate quick movement from one section of the bill to another. In this example, there is a “Summary” tab that references the billing page shown in the figure. Activation of a “Details” tab (via a mouse pointer, for example) changes the screen from the summary page to one or more pages itemizing the billing transactions. A “Customer Service” tab switches to a page giving instructions on how to access customer service.

The billing statement 80 has a main body 86 that contains numerous data fields for the billing particulars. On the summary page of the energy bill, the billing data fields in body 86 might include an amount due, an amount previously paid, and due date. On the “Details” page, the data fields in the body might include line items detailing a purchase date, purchase order number, invoice number, item number, description of item, quantity, price, total, tax, and amount due.

The billing statement in FIG. 4 is merely one example. There are infinitely many ways to organize and present data. In addition, the billing statement may contain other items, such as embedded hyperlinks, executable code, and pop-up dialog boxes, which provide additional design flexibility and customization. The biller can essentially create any aesthetics, organization, and detail that it prefers.

The billing statement 80 is rendered within a branding frame 88 that identifies the bank. The frame 88 contains at least some of the branding indicia, such as the bank's name and logo 52. As a result, the ability to open and review a personal billing statement 80 appears to be part of the services offered by the bank, even though the billing data is being provided by the remote service center system 24.

### Exemplary Implementation of Servers at Banks and Service Center

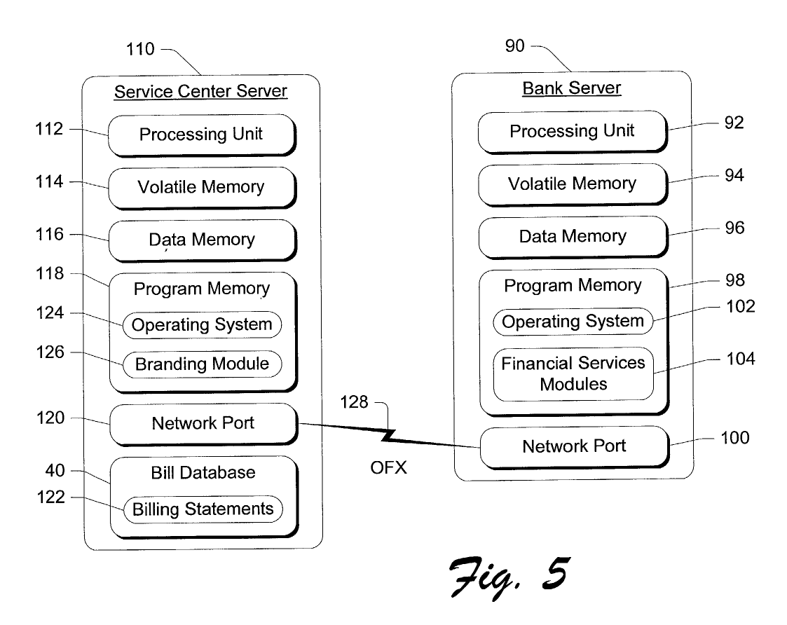

FIG. 5 shows a Web server 90 resident at the bank and a Web server 110 resident at the service center. The bank's server 90 has a processing unit 92, a volatile memory 94 (e.g., RAM), a non-volatile data memory 96 (e.g., disk drive, etc.), a non-volatile program memory 98 (e.g., ROM, disk drive, CD-ROM, etc.), and a network port 100 (e.g., modem, network card, ISDN connection, etc.). As an example, the bank's server 90 can be implemented as a conventional personal computer (PC) configured to run a server operating system 102, such as Windows NT from Microsoft Corporation. More particularly, the bank's server 90 runs a version of Windows NT that supports an Internet Web site, such as Internet Information Server from Microsoft Corporation. The computer components are interconnected by an electronic interconnect structure which consists of parallel and serial conductors, such as SCSI-, PCI-, and RS 232-compatible conductors (not shown).

The bank's server 90 runs a set of financial services software modules 104, such as Microsoft Internet Finance Server Tookkit (MIFST), which are stored in program memory 98. The modules 104 run atop the operating system 102 during execution in the processing unit 92. The financial services software modules 104 support the Open Financial Exchange (OFX) protocol, a published standard for exchanging financial data. The OFX protocol is used in personal finance software, such as Money from Microsoft Corporation and Quicken from Intuit. The OFX protocol is well-known and is documented at the Web site “www.OFX.net”.

The server center's server 110 has a processing unit 112, a volatile memory 114 (e.g., RAM), a non-volatile data memory 116 (e.g., disk drive, etc.), a non-volatile program memory 118 (e.g., ROM, disk drive, CD-ROM, etc.), a network port 120 (e.g., modem, network card, ISDN connection, etc.), and a non-volatile bills database 40. The bills database 40 stores the billing statements data 122.

The service center's server 110 can also be implemented as a conventional personal computer (PC) configured to run a server operating system 124, such as Windows NT from Microsoft Corporation. More particularly, the service center's server 110 preferably runs a server package for Windows NT that is marketed under the name “Microsoft Internet Financial Server Toolkit” or “MIFST”, which is commercially available from Microsoft Corporation. MIFST support the Open Financial Exchange (OFX) protocol The computer components in server 110 are interconnected by an electronic interconnect structure which consists of parallel and serial conductors, such as SCSI-, PCI-, and RS 232-compatible conductors (not shown).

The service center's server 110 runs a branding software module 126, which are stored in program memory 118. The branding module 126 runs atop the operating system 124 during execution in the processing unit 112. The branding module 126 extracts the branding indicia passed from the bank and uses it to create a Web page that appears like the bank's own Web pages. It is noted that the branding module 126 may be integrated as part of the Web server software, rather than executed as a standalone application.

The two servers are loosely coupled via a data connection 128. This data connection may be as simple as a handoff from the bank server 90 to the service center server 110 as a result of following a link presented on the bank's Web page. Alternatively, the connection 128 might represent a secure communications path established between the two servers and secured using cryptographic technologies. The data connection 128 employs the OFX protocol.

### Low Level of Integration Between Bank and Service Center

The banks 26 cooperate with the service center 24 in a way that allows the service center 24 to provide customer-specific data, such as billing statements, to customers under the guise of the banks. The banks and service center can enter into various levels of integration, ranging from a low level of integration in which the banks' Web sites provide links to the service centers' Web site to a high level of integration in which the banks and service center communicate over secure connections using the Open Financial Exchange (OFX) protocol to exchange financial data. Between the first and second levels is a gradient of increasing integration between the banks and the service center, both contractually and technologically. The two integration levels are described in this disclosure for discussion purposes, beginning with the low level and followed by the high level.

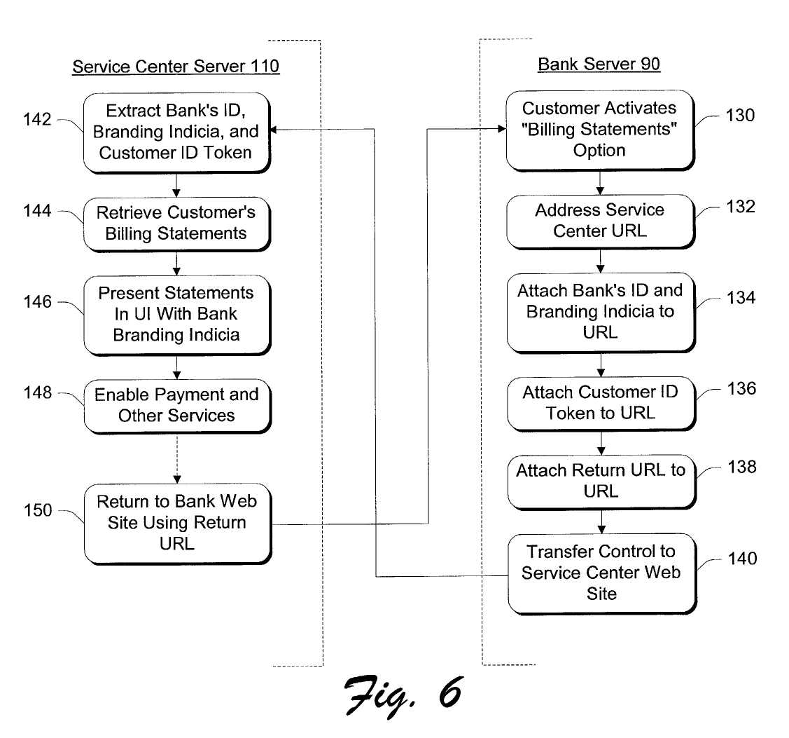

FIG. 6 shows a method for implementing the low level of integration between the bank and the service center. The process begins at step 130 when a customer activates the “Billing Statements” option 60 in the bank's home page 50 (FIG. 2). In response to this activation, the bank server 90 addresses the URL (universal resource locator) of the service center Web site 46 (step 132). The bank's server 90 attaches its ID to the URL address (step 134). At the simplest level, the bank only submits its ID, as follows:

SCSite.com?from=Bank1

where “SCSite.com” is the URL for the service center site, the tag “from=bank1” indicates that the customer is being forwarded from bank 1. The service center inserts the appropriate bank's name when presenting the customers bills. At this basic level, the customer may be asked to log on or enter some sort of ID. Since this may be the second time the customer is asked for such information, it would be advantageous to provide more information in the transfer, including the customer ID (described below).

At a slightly higher level of sophistication, the bank may attach branding indicia (e.g., name, logo, color scheme, background genre, etc.) to the URL address (step 134). The branding module 126 executing at the service center's server 110 uses the branding indicia to create an HTML page that more closely resembles the bank's own Web pages.

At step 136, the bank server 90 further attaches a customer ID token that identifies the particular customer. This token ranges in various degrees of sophistication, depending upon the level of integration. At the most basic level, the token merely contains the customer's ID. However, the token may further contain a bank's ID, a date, an expiration date, and so forth. The date and expiration date information sets a time period in which the token is valid, and after which the token is invalid. In this case, the service center only responds to messages containing non-expired tokens, while rejecting those with expired tokens.

At step 138, the bank server 90 attaches a return URL address for the bank so that the service center can return the customer to the bank when the customer finishes his/her review of the billing statements. The composite message string is forwarded to the service center's server 110 to thereby transfer control to the service center Web site (step 140). The composite string may appear, for example, as follows:

SCSite.com?from=Bank1&branding=Bank1BrandingIndicia& token=customer1&return=Bank1.com

where SCSite.com is the URL for the service center site, the tag “\from=bank1” indicates that the customer is being forwarded from bank 1, the tag “branding=Bank1BrandingIndicia” contains certain branding items custom to the bank, the tag “token=customer1” identifies the customer, and the tag “return=Bank1.com” is the return URL to the bank.

Security is provided by transport using an SSL or similar protocol. Authentication can be provided by including a bank authentication token, such as a bank password.

At step 142 in FIG. 6, the service center's server 110 extracts the bank's ID, any branding indicia, and the customer ID token. The service center's server 110 uses the customer ID in the token to locate and retrieve the customer's personal billing statements (step 144). The service center's server 110 then uses the branding indicia to create a user interface (UI) that presents a list of the customer's billing statements under the guise of the bank's genre (step 146).

As one example, the service center server 110 has an HTML document that contains data fields for holding billing data retrieved locally from the bills database 40 and indicia fields for holding the branding indicia received remotely from the bank. The HTML document is rendered by the customer's browser program to present a UI that appears as though the bank itself presented the billing statements. This is shown in FIG. 3, for example, where the service center server 110 provides an HTML Web page 70 that contains a billing statement list 72 with data from the bills database 40, along with branding indicia 52, 54 received from the bank.

At step 148 in FIG. 6, the service center server 110 offers a set of bill management and payment options to the customer. The customer may elect to examine the billing statements in detail by clicking on a particular bill in the list. The server 110 provides a new HTML page showing the billing statement framed within the bank's branding indicia, as shown in FIG. 4. The customer may further elect to pay all of the bill, part of it, or none of it. The customer may challenge part, or enter into a dialog with customer service.

After the biller is finished reviewing his/her billing statements, the service center server 110 returns the customer to the bank server 90 via the return URL for the bank (step 150). The customer may then continue to explore other services offered by the bank's, such as transferring funds between accounts to cover payment of the bills.

### Higher Levels of Integration Between Bank and Service Center

The banks and service center may elect to more closely integrate their services in a number of ways that are founded on the Open Financial Exchange protocol. There are six primary areas for increased integration:

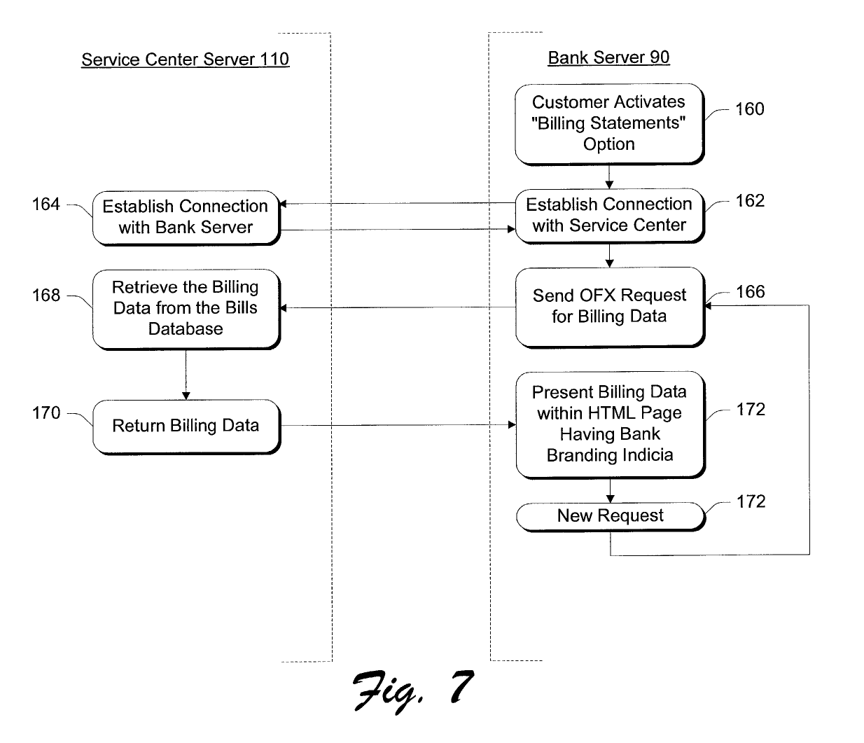

1. Improve the customer interface served by the bank's server 90 to leverage services offered by the service center 24. This integration point is implemented at the simplest level by transferring the bank's ID and branding indicia, as described above. In higher levels of integration, the bank maintains control of the user interface displayed to the customer. The bank server requests billing data from the service center server and presents the billing data within its own Web pages that maintain the same look and feel for consistent customer interface. This aspect is described below with respect to FIG. 7.

2. Integrate customer enrollment so that the customer only enrolls once at the bank 26, and not a second time when accessing resources provided by the service center 24. For this integration point, the bank submits the names and addresses of new customers to the service center by transferring them on a diskette or using automated online batch or real-time processes.

3. Integrate customer logon so that the customer only logs on once at the bank 26, and not a second time when accessing resources provided by the service center 24. At the lowest level, the customer is asked to log on a second time at the service center Web site, which is not desirable. At higher levels of integration, the bank 26 sends along the customer's ID in token form as a way to automatically identify the customer to the service center.

4. Integrate payment services of service center and any other bill payment provider associated with the bank. This integration point allows the service center to jointly present bills that it services and bills serviced by a bill payment provider, such as CheckFree or other companies. Depending upon the level of integration, the service center server can provide a unified list of all billing statements, or separate lists that distinguish between the bills serviced by the service center and the bills provided by the third party provider.

5. Integrate settlement procedures when a customer pays a bill using services provided by the service center. Settlement procedures can be handled via existing ACH (Automated Clearinghouse) networks, or by batch or real-time requests to the financial institutions involved in the transaction.

6. Integrate customer service functions so that concerns raised by customers over the telephone, or via email, are serviced by the third party where appropriate. In this manner, customer service questions directed to services supported locally by the bank can be handled locally by the bank, whereas questions directed to billing statements can be transferred and handled by the service center.

Some of these areas primarily involve technological integration, while others more heavily involve business cooperation. To enable many of these higher level integrations, the inventors derived extensions to the existing OFX protocol.

To provide an example of one type of higher level integration, FIG. 7 shows steps in an exemplary method for implementing the low level of integration between the bank and the service center. The process begins at step 160 when a customer activates the “Billing Statements” option 60 in the bank's home page 50 (FIG. 2). At steps 162 and 164, the bank server 90 and the server center server 110 establish a data connection. This connection is preferably a secure connection, wherein the bank server and the service center server perform a cryptographic key exchange or certificate exchange to authenticate each other and then employ encryption/decryption processes to protect against eavesdroppers and tampering third parties.

The reader is assumed to be familiar with cryptography and techniques for securing communications over an otherwise unsecured communications path. For a basic introduction to cryptography, the reader is directed to a text written by Bruce Schneier and entitled, “Applied Cryptography: Protocols, Algorithms, and Source Code in C,” published by John Wiley & Sons, copyright 1994 (second edition 1996), which is hereby incorporated by reference.

With a connection established, the bank server 90 can request and receive billing data from service center server 110 for presentation to the customer. In this manner, control is not transferred to the service center Web site; instead, the billing data is uploaded from the service center server 110 in response to OFX messages sent by the bank server.

As one example, the bank server 90 may send a message requesting a summary of the customer's billing status (step 166). This message would be implemented as a custom tag within OFX. In response to this message, the service center server 110 retrieves specific billing data for the customer from the bills database 40, such as the number of past due bills, number of current bills, number of new bills, number of current statements, number of new statements, number of current billing notices, number of new billing notices, value of all bill payments that are pending, and value of all current bills (step 168). This service center server 110 returns this billing data to the bank server 90 (step 170).

The bank server 90 incorporates the billing data received from the service center server 110 into a Web page, and presents the page to the customer (step 172). Since the Web page is designed and rendered by the bank, the page has the same look and feel as the other Web pages, leaving the customer to believe that the bank, rather than the third party, is providing the billing data.

This process is repeated as the customer navigates the Web pages and calls for billing data supplied by the service center server (step 174).

The customer's status summary is an example of one request that the inventors developed as an extension to OFX. In addition to this extension, other extensions include:

1. An OFX extension to an Enrollment request that adds bank account information. The enrollment process notifies the service center of the name and address of potential customers who intend to use the billing services of the center. The service center would like to know a demand deposit account (DDA) for payments to come from. The OFX specification does not explicitly accommodate this. An OFX extension to the Enrollment request <ENROLLRQ> lists all of the accounts that a person holds with their bank. The extension includes a tag indicating the beginning of the list of bank aggregates, a list of one or more bank accounts that the customer has with the bank, and a list of zero or more credit card accounts that the customer has with the bank.

2. An OFX extension to a Change User Information request that adds bank account information. The bank generates a change user information request, <CHGUSERINFORQ>, which includes a list of the accounts that a customer can pay bills from. The service center returns a change user information response, <CHGUSERINFORS>, which lists the bank and credit card accounts that the customer currently has registered at the service center.

3. An OFX extension to a Bill List request that separates different types of bills. The OFX specification allows a bank to list all of the items sent to a customer within a given time period. Most banks will want to break this list up into different types of items and different statuses of items. In order to accommodate this, an extra tag <SC.FLAGS> for the bill list request is defined. This tag contains flags specifying which types and statuses to return. This tag also enables banks to sort through a list of returned items.

4. An OFX command that adds status and type information to bills.

5. An OFX command that adds payment information to the summary of the presented bills. Banks may want to display summary information about a customer's bills as soon as they log on before entering the bill presentment area of the web site. Summary information will be returned within a <SUMMARY> aggregate in the <PRESLISTRS> response. The tags in the <SUMMARY> aggregate will provide a variety of information that the bank may wish to display, including past due bills, current bills, new bills, current statements, new statements, new current notices, new notices, value payment schedule, and the value of current bills.

6. OFX extensions to the payment status codes to include information on payment delivery.

7. OFX Extensions to allow the financial institution to assign an identifier to payments that the financial institution initiates. Clients pass in a unique identifier when requesting payment of bills. These identifiers are unique to the client and tracked at the service center. In the response, the service center returns a server transaction identifier. To modify or cancel the payment, the transaction can be identified by either the client identifier or the server identifier.

8. OFX Extensions to allow a financial institution to mark a bill as filed without being paid. If a client wants to mark a bill as filed without paying it, the client sends a file request to the service center. To remove the status of ‘filed’ from a bill, an activate request > is sent to the service center.

### Bill List Request

One example implementation of the extensions to the Bill List request (i.e., Items 3-6 above) is described below in more detail.

A bank can request a list of items on behalf of the customer by placing a <PRESLISTRQ> request within a standard <PRESLISTTRNRQ> transaction wrapper. Two custom aggregates are added to the <PRESLISTRQ> request to enable the bank to choose which bills to list.

| Tag | Description |
|---|---|
| <PRESLISTRQ> | Opening tag for bill list request |
| <BILLPUB> | Official standard name of bill publisher |
| <DTSTART> | If present, indicates earliest date for which to |
| | include bills |
| <DTEND> | If present, indicates the latest date for which to |
| | include bills |
| <NOTIFYWILLING> | Flag indicating that client is prepared to send |
| | notifications of bill delivery. |
| <INCLUDEDETAIL> | Flag indicating bill detail should be included |
| | too. |
| <RETURNURL> | URL to return the user to after an item has |
| | been viewed. If not provided, then the user |
| | will be returned to the URL that the link was |
| | called from. |
| <FLAGS> | Flags representing the type and status of items |
| | requested. If the tag is not present then all |
| | items for the time period specified will be |
| | returned |
| </PRESLISTRQ> | |

The <FLAGS> value is a 32 digit decimal number. Each digit is interpreted as a flag indicating that a certain type or status of item should be present. Digits 1-16 represent types that can be returned such as bills, statements, and notices. Digits 17-32 represent statuses that can be returned such as current, payment scheduled, payment delivered, filed, past due, or new.

By placing a 1 in the appropriate digit, it is possible to select a certain type or status of item to be returned. All of the types which have non-zero values associated with their digits and all of the statuses that have non-zero values associated with their digits will be returned. To return no items at all, a value of 0 can be passed for the entire tag. In this case, the <DTSTART> and <DTEND> flags will not be returned in the response.

To return all items for the specified time period, the tag can either be set to entirely 1's or not included in the request since the default is to send all items. The <FLAGS> type is also used to identify what type and status a particular item is within the <PRESBILLINFO> aggregate. In this case, all of the appropriate digits for the type and status of the item will be set to 1 and the other digits will be zero. The table below outlines the significance of the digits in the flag. Digit 1 is the furthest left digit and digit 32 is the furthest right.

TABLE 1

| <FLAGS>Digit | Represents | Description |
|---|---|---|
| 1 | Bill | Items that have a positive amount due |
| 2 | Statement | Items originating from outside of |
| | | MSFDC without a positive amount due |
| 3 | Notice | Items originating from within service |
| | | center containing information about the |
| | | service |
| 4-16 | Unassigned | These digits are not yet referenced |
| 17 | Current | Items that are not filed and do not have a |
| | | payment associated with them. |
| 18 | Payment | Bills for which a payment has been |
| | Scheduled | scheduled |
| 19 | Payment | Bills for which a payment has been |
| | Delivered | delivered to the biller |
| 20 | Filed | Items that have been marked as filed by |
| | | the user |
| 21 | New | Items which have not been displayed yet |
| 22 | Past Due | Bills which have a date due in the past |
| | | and are not filed and do not have a |
| | | payment associated with them |
| 23-32 | Unassigned | These digits are not referenced by |
| | | MSFDC yet |

As an example, to request all bills that have a payment scheduled or a payment delivered, the value of the <FLAGS> tag would be:

10000000000000000110000000000000

The service center responds with a <PRESLISTRS> message that contains a flag that is the same as the one in the request, as well as summary information about the status of the customer's accounts. The summary information is independent of the type and status of items requested.

| Tag | Description |
|---|---|
| <PRESLISTRS> | Opening tag for bill list response |
| <BILLPUB> | Official standard name of bill |
| | publisher |
| <USERID> | User whose bill data is being |
| | returned |
| <DTSTART> | Start date of bills returned. |
| | Only present if the |
| | <PRESLIST> aggregate is being |
| | returned |
| <DTEND> | Date to present as start date for next |
| | request. Only present if the |
| | <PRESLIST> aggregate is being |
| | returned |
| <FLAGS> | Flags representing the type and |
| | status of bills requested |
| <SUMMARY> | Opening tag for the summary |
| | information about the customer. |
| <NUMCURRENTBILLS> | Number of bills which are not paid or |
| | filed |
| <NUMNEWBILLS> | Number of bills which have not been |
| | viewed |
| <NUMCURRENT . . | Number of statements which have not |
| . . STATEMENTS> | been filed |
| <NUMNEWSTATEMENTS> | Number of statements which have not |
| | been viewed |
| <NUMCURRENTNOTICES> | Number of notices which have not |
| | been filed |
| <NUMNEWNOTICES> | Number of notices which have not |
| | been viewed |
| <NUMPASTDUE> | Number of bills which have not |
| | been paid or filed and have a |
| | date due in the past |
| <VALUEPMTSCHEDULED> | Total value of payments which have |
| | been scheduled for the future |
| <VALUECURRENTBILLS> | Total value of bills which have |
| | not been paid or filed |
| </MSFDC.SUMMARY> | |
| </PRESLIST> | Opening tag for bill summary list |
| </PRESBILLINFO> | One or more bill information |
| | aggregates |
| </PRESBILLINFO> | |
| </PRESLIST> | |
| </PRESLISTRQ> | |

The URL returned in the <STMTIMAGE> aggregate of the <PRESBILLINFO> structure is valid at the service center. However, this URL expires at the date and time specified by the <DTEXPIRE> tag in the <STMTIMAGE> aggregate. This means that the bank may need to request a new URL with another <PRESLISTRQ> request if the previous URL has expired.

The <PRESBILLINFO> aggregate contains information about payments made against the bill. This information is included in the custom aggregate, <PMTUPDATELIST>, as a list of <PMTUPDATE> aggregates (each with the same structure as the <PMTMODRS> response). For more information on the <PMTMODRS> response see section 12.6.2 of the OFX specification.

| Tag | Description |
|---|---|
| <PRESBILLINFO> | Opening tag for bill information aggregate |
| <FITID> | Identifier for this bill |
| <PRESACCTFROM> | Biller account information |
| </PRESACCTFROM> | |
| <PAYEEID> | Payee identifier. |
| <REMITTOKEN> | Biller defined text to include with the payment, |
| | for the biller's Account Receivable |
| | reconciliation. |
| <AMTDUE> | Full payment amount due |
| <MINAMTDUE> | Minimum payment amount due |
| <DTPMTDUE> | Payment due date |
| <DTBILL> | Bill date |
| <DTOPEN> | Opening statement date |
| <DTCLOSE> | Closing statement date |
| <PREVBAL> | Balance of the account as of the previous |
| | period |
| <AMTPAID> | Net payments received and credited to the |
| | account since the last period |
| <BAL> | Balance of the account prior to the bill being |
| | sent. |
| <STMTIMAGE> | Statement image aggregate |
| <BILLERINFO> | Biller information aggregate. |
| </BILLERINFO> | |
| <MSFDC.FLAGS> | Flags indicating the type and status of the item |
| <PMTUPADTELIST> | Opening tag for a list of payments initiated |
| | within this bill. |
| PMTUPDATE> | One or more payment information aggregates |
| | for each of the payments which have been |
| | made by the service center through this |
| | bill. |
| <SRVRTID> | ID Assigned by the server to the payment being |
| | modified |
| <PMTINFO> | Payment information aggregate |
| </PMTINFO> | |
| <PMTPRCSTS> | Payment processing status |
| </PMTPRCSTS> | |
| </PMTUPDATE> | |
| </PMTUPDATELIST> | |
| </PRESBILLINFO> | |

Within the <PMTPRCSTS> payment status aggregate is a <PMTPRCCODE> code that signifies the status of the payment. The service center provides more information about processing status than is currently provided for in the list of payment status codes in the OFX specification. Extending the codes provides the banks with more information about payment status to pass to their customers such as when a biller received a payment.

| <PMTPRCCODE> Value | Description |
|---|---|
| WILLPROCESSON | Will be processed on <DTPMTPRC> |
| PROCESSEDON | Was processed for payment on |
| | <DTPMTPRC> |
| NOFUNDSON | Funds not available to make payment on |
| | <DTPMTPRC> |
| FAILEDON | Unable to make payment for unspecified |
| | reasons on <DTPMTPRC> |
| CANCELEDON | User cancelled payment on <DTPMTPRC> |
| MSFDC.DELIVEREDON | Payee received the payment from MSFDC |
| | on <DTPMTPRC> Not the same |
| | as the payee posting the payment to |
| | the customer's account so the |
| | account could still be outstanding. |

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

What is claimed is:

1. In a network-based system, a computer-implemented method comprising:
presenting a page on a network site sponsored by a hosting entity;
offering as part of the page an option to view user-specific data, wherein the user-specific data is located at a network site owned by a third party that is independent from the hosting entity;
registering the particular user with the hosting entity;
whereupon activation of the option on the hosting entity's page by a particular user of the hosting entity, linking to the third party's network site;
enabling access to the third party's network site without registering the particular user with the third party; and
presenting, to the particular user, a new page at the third party's network site that incorporates the user-specific data.

2. A computer-implemented method as recited in claim 1, wherein the linking comprises addressing a universal resource locator (URL) for the third party's network site.

3. A computer-implemented method as recited in claim 1, wherein the linking comprises establishing a secure data connection between the hosting entity and the third party.

4. A computer-implemented method as recited in claim 1, further comprising supplying a return universal resource locator (URL) to the third party's network site for use in returning to the hosting entity's network site.

5. A computer-implemented method as defined in claim 1, wherein:
the page on the network site sponsored by the hosting entity identifies the hosting entity;
the linking to the third party's network site does not expose this transfer to the particular user; and
the presenting, to the particular user, the new page at the third party's network site also identifies the hosting entity without identifying a network address of the third party's network site.

6. A computer-implemented method as recited in claim 1, further comprising displaying a logo of the hosting entity on the new page at the third party's network site.

7. A computer-implemented method as recited in claim 1, wherein the linking comprises addressing a universal resource locator (URL) associated with the third party's network site and sending an identity of the hosting entity to the third party so that the third party may identify the hosting entity in the new page.

8. A computer-implemented method as recited in claim 1, wherein the linking comprises supplying, to the third party network site, page formatting information that is used by the third party network site to present the new page, the page formatting information enabling an appearance of the new page that resembles the page presented by the hosting entity's network site.

9. A computer-implemented method as recited in claim 1, wherein the linking comprises:
connecting to the third party's network site; and
uploading navigation information from the third party network site to the hosting entity network site that may be used by the particular user to navigate the user-specific data resident at the third party network site.

10. A computer-implemented method as recited in claim 1, wherein:
the linking comprises addressing a universal resource locator (URL) associated with the third party's network site and sending a token identifying the particular user; and
using the token to locate the user-specific data for the particular user.

11. A computer-implemented method as recited in claim 1, wherein presenting, to the particular user, the new page at the third party's network site that incorporates the user-specific data further comprises:
offering as part of the new page an option to activate an additional function selected from the group consisting of an embedded hyperlink, an executable code segment, and a pop-up dialog box; and
activating the additional function upon the activation of the option to activate the additional function.

12. A computer-readable media comprising computer-executable instructions for performing the method as recited in claim 1.

13. In a network-based system, a computer-implemented method comprising:
presenting a page on a network site sponsored by a hosting entity to a particular user;
requiring the particular user to logon with the hosting entity's network site;
offering as part of the page an option to view user-specific data, wherein the user-specific data is located at a network site owned by a third party that is independent from the hosting entity;
whereupon activation of the option on the hosting entity's page by the particular user of the hosting entity, linking to the third party's network site;
enabling access to the third party's network site without logging on the particular user with the third party's network site; and
presenting, to the particular user, a new page at the third party's network site that incorporates the user-specific data.

14. A computer-implemented method as defined in claim 13, wherein:
the page on the network site sponsored by the hosting entity identifies the hosting entity;
the linking to the third party's network site does not expose this transfer to the particular user; and
the presenting, to the particular user, the new page at the third party's network site also identifies the hosting entity without identifying a network address of the third party's network site.

15. A computer-implemented method as recited in claim 13, further comprising displaying a logo of the hosting entity on the new page at the third party's network site.

16. A computer-implemented method as recited in claim 13, wherein the linking comprises addressing a universal resource locator (URL) associated with the third party's network site and sending an identity of the hosting entity to the third party so that the third party may identify the hosting entity in the new page.

17. A computer-implemented method as recited in claim 13, wherein the linking comprises supplying, to the third party network site, page formatting information that is used by the third party network site to present the new page, the page formatting information enabling an appearance of the new page that resembles the page presented by the hosting entity's network site.

18. A computer-implemented method as recited in claim 13, wherein the linking comprises:
connecting to the third party's network site; and
uploading navigation information from the third party network site to the hosting entity network site that may be used by the particular user to navigate the user-specific data resident at the third party network site.

19. A computer-implemented method as recited in claim 13, wherein:
the linking comprises addressing a universal resource locator (URL) associated with the third party's network site and sending a token identifying the particular user; and
using the token to locate the user-specific data for the particular user.

20. A computer-implemented method as recited in claim 13, wherein presenting, to the particular user, the new page at the third party's network site that incorporates the user-specific data further comprises:
offering as part of the new page an option to activate an additional function selected from the group consisting of an embedded hyperlink, an executable code segment, and a pop-up dialog box; and
activating the additional function upon the activation of the option to activate the additional function.

21. A computer-readable media comprising computer-executable instructions for performing the method as recited in claim 13.

22. In a network-based system, a computer-implemented method comprising:
presenting a page on a network site sponsored by a hosting entity;
enabling users to register with the hosting entity in order to access information on the network site;
offering as part of the page an option to view user-specific data wherein the user-specific data is located at a network site owned by a third party that is independent from the hosting entity; and
whereupon activation of the option on the hosting entity's page by a particular user of the hosting entity, linking to the third party's network site without requiring the particular user to first register with the third party and presenting a new page at the third party's network site.

23. A computer-implemented method as recited in claim 22, wherein the new page does not identify a network address associated with the third party's network site.

24. A computer-implemented method as recited in claim 22, wherein the presenting a new page at the third party's network site further comprises:
offering as part of the new page an option to activate an additional function selected from the group consisting of an embedded hyperlink, an executable code segment, and a pop-up dialog box; and
activating the additional function upon the activation of the option to activate the additional function.

25. In a network-based system, a computer-implemented method comprising:
presenting a page on a network site sponsored by a hosting entity;
prompting users to log on to the network site prior to permitting access to information on the network site;
offering as part of the page an option to view user-specific data wherein the user-specific data is located at a network site owned by a third party that is independent from the hosting entity; and
whereupon activation of the option on the hosting entity's page by a particular user of the hosting entity, linking to the third party's network site without requiring the particular user to log on to the third party's network site and presenting a new page at the third party's network site that incorporates the user-specific data.

26. A computer-implemented method as recited in claim 25, wherein the new page does not identify a network address associated with the third party's network site.

27. A computer-implemented method as recited in claim 25, further comprising sending a token identifying the particular user to the third party.

28. A computer-implemented method as recited in claim 25, further comprising:
forming a token identifying the particular user;
encrypting the token using a public key of the third party; and
sending the token to the third party.

29. A computer-implemented method as recited in claim 25, wherein the linking to the third party's network site without requiring the particular user to log on to the third party's network site further comprises:
the hosting network site and the third party's network site performing a security exchange to authenticate one another; and
employing encryption/decryption processes to protect against eavesdroppers and tampering third parties.

30. A computer-implemented method as recited in claim 29, wherein the security exchange is a cryptographic key exchange or a certificate exchange.

31. A computer-implemented method as recited in claim 25, wherein the linking to the third party's network site further comprises:
offering on the new page at the third party's network site an option to activate an additional function selected from the group consisting of an embedded hyperlink, an executable code segment, and a pop-up dialog box; and
activating the additional function upon the activation of the option to activate the additional function.

32. A computer-readable media comprising computer-executable instructions for performing the method as recited in claim 25.

33. An electronic system for a network, comprising:
a network server to support a network site sponsored by a hosting entity, the server presenting a page for the hosting entity's network site that offers an option to view user-specific data, wherein the user-specific data is located at a third party that is independent from the hosting entity;
a server located at the third party to store the user-specific data; and
whereupon activation of the option on the hosting entity's page by a particular user of the hosting entity, the network server being configured to link to the third party's server by establishing a secure data connection between the hosting entity and the third party.

34. An electronic system as recited in claim 33, wherein the link to the third party's server does not expose this transfer to the particular user.

35. An electronic system as recited in claim 33, wherein the third party's server is a network server that supports pages, the third party's server being configured to present, to the particular user, a new page that incorporates the user-specific data, the new page identifying the hosting entity and veiling the third party's identity to lead the particular user to believe that the user-specific data is provided by the hosting entity rather than the third party.

36. An electronic system as recited in claim 33, wherein the third party's server supplies navigation data to the hosting entity network server that may be used by the particular user to navigate the user-specific data resident on the third party's server

37. An electronic system as recited in claim 33, wherein the hosting entity's network server links to the third party server by addressing a universal resource locator (URL) for the third party's network site.

38. An electronic system as recited in claim 33, wherein the hosting entity's network server sends a token identifying the particular user to the third party's server for use in locating the user-specific data for the particular user.

39. A program for an electronic system, the program being embodied on a computer-readable medium and executed on a server at a hosting entity, the program comprising:
a code segment that, upon execution, renders a page sponsored by the hosting entity, the page containing an option to view data specific to a particular user that is located at a remote server owned by a third party that is independent from the hosting entity;
a code segment that, upon execution, formulates a token comprising at least one of the identity of the particular user, a data, an expiration date, and an identity of the hosting entity;
a code segment that, upon execution, encrypts the token;
a code segment that, upon execution, passes the encrypted token to the remote server; and
a code segment, responsive to activation of the option by the particular user, that, upon execution, transfers control to the remote server without exposing the transfer to the particular user and to pass an identity of the particular user to the remote server to enable the remote server to present the data specific to the particular user.

40. A program as recited in claim 39, wherein:
the remote server is a network server; and
the program further comprises a code segment that, upon execution, activates a universal resource locator (URL) of the remote network server to transfer control to the remote network server.

41. A program as recited in claim 39, wherein the code segment that, upon execution, enables the remote server to present the data specific to the particular user enables the remote server to:
present an option to activate an additional function selected from the group consisting of an embedded hyperlink, an executable code segment, and a pop-up dialog box; and
activate the additional function upon the activation of the option to activate the additional function.

42. A program as recited in claim 39, wherein the code that, upon execution, transfers control to the remote server does not expose the transfer to the particular user.

43. A program for an electronic system, the program being embodied on a computer-readable medium and executed on a server at a hosting entity, the program comprising:
a code segment that, upon execution, renders a first page sponsored by the hosting entity, the first page containing an option to view data specific to a particular user that is submitted to a third party by a fourth party, the data specific to the particular user electronic being located at a remote server owned by the third party that is independent from the hosting entity;
a code segment, responsive to activation of the option by the particular user, that, upon execution, establishes a secure data connection between the hosting entity and the third party at the remote server and to obtain the data specific to the particular user; and
a code segment that, upon execution, renders a second page that presents the data specific to the particular user.

44. The program as defined in claim 43, wherein the second page does not present a network address associated with the remote server and thereby appears as if the hosting entity provided the data specific to the particular user.

45. A program for an electronic system, the program being embodied on a computer-readable medium and executed on a server that has access to electronic user specific data, comprising:
a code segment that, upon execution, receives a request from a hosting entity to review the electronic user specific data belonging to a particular user of the hosting entity, the request containing indicia that identifies the hosting entity and an identity of the particular user;
a code segment that, upon execution, establishes a secure connection with both the particular user and a hosting entity from which to retrieve the electronic user specific data belonging to the particular user; and
a code segment that, upon execution, presents the electronic user specific data.

46. The program as defined in claim 45, wherein the code segment that, upon execution, presents the electronic user specific data does so without presenting a network address so as to lead the particular user to believe that the user interface is sponsored by the hosting entity.
